(19) United States
(12) Patent Application Publication
(10) Pub. No.: US 2018/0325088 A1
(43) Pub. Date: Nov. 15, 2018

(54) INSECT TRAP AND METHOD OF MAKING SAME

(71) Applicant: Willert Home Products, Inc., Saint Louis, MO (US)

(72) Inventor: Bryan Bruce Willert, Saint Louis, MO (US)

(21) Appl. No.: 15/595,452

(22) Filed: May 15, 2017

(51) Int. Cl. A01M 1/10; A01M 1/02

(52) U.S. Cl. CPC A01M 1/106; A01M 2200/012; A01M 1/10; A01M 1/02

(57) ABSTRACT

An insect trap includes a rigid canister and a nozzle. The canister has a bottom wall and a plurality of side walls projecting from the bottom wall. The side walls define a top opening. The nozzle is secured within the top opening. The nozzle includes a tube defining a passageway for insects to enter into the canister and a lid moveable between an open position and a closed position. The nozzle inhibits insects that have entered the canister from exiting through the passageway. The lid selectively seals the passageway when the lid is positioned in the closed position.

### BACKGROUND OF THE DISCLOSURE

The subject matter described herein relates generally to an insect trap and, more particularly, to a trap for flying insects and a method of making the same.

It is common for flying insect traps to include a container and a port coupled to the container. The container houses a substance that attracts flying insects to the port, and the port is designed to permit insects to enter the container while inhibiting their exit from the container. Thus, flying insects that enter the container tend to become trapped therein, and ultimately perish inside the container. However, there are occasions where it is desirable to temporarily seal the port of the container to facilitate either preventing insects from being attracted to the port or containing the unpleasant scent that results from insects perishing inside the container.

### BRIEF DESCRIPTION OF THE DISCLOSURE

In one aspect, an insect trap includes a rigid canister and a nozzle. The canister has a bottom wall and a plurality of side walls projecting from the bottom wall. The side walls define a top opening. The nozzle is secured within the top opening. The nozzle includes a tube defining a passageway for insects to enter into the canister, and a lid. The lid selectively seals the passageway.

In another aspect, a method of making an insect trap is provided. The method includes forming a lid for a nozzle, wherein the nozzle includes a tube. The lid is moveable between an open position and a closed position with respect to the nozzle. The method further includes positioning the nozzle between a plurality of side walls of a rigid canister that define a top opening, and coupling the nozzle to the side walls such that the tube of the nozzle defines a passageway for insects to enter into the canister. The lid selectively seals the passageway when the lid is positioned in the closed position.

In another aspect, a nozzle for an insect trap having a rigid canister including a bottom wall and a plurality of side walls projecting from the bottom wall is provided. The side walls of the canister define a top opening. The nozzle includes a tube defining a passageway for insects into the canister when said nozzle is coupled to the canister within the top opening, and a lid that is moveable between an open position and a closed position. The lid selectively seals the passageway when positioned in the closed position.

### BRIEF DESCRIPTION OF THE DRAWINGS

FIG. 1 is a perspective view of an exemplary insect trap;

FIG. 2 is an exploded view of the trap shown in FIG. 1;

FIG. 3 is a perspective view of a nozzle of the trap shown in FIG. 2; and

FIG. 4 is a top view of the nozzle shown in FIG. 3.

### DETAILED DESCRIPTION OF THE DISCLOSURE

The exemplary embodiments described herein provide an apparatus that is useful for trapping flying insects such as nuisance flies, but could also be used against other types of insects and/or animals. More specifically, the apparatus is a trap that lures flying insects into a canister via a nozzle, wherein the nozzle is constructed to inhibit the insects from exiting the canister via the nozzle. The canister is able to stand upright on a support surface or be hung from a suitable structure. The nozzle snaps onto the canister for ease of assembly, and the nozzle is provided with an integrally formed lid for temporarily sealing the canister.

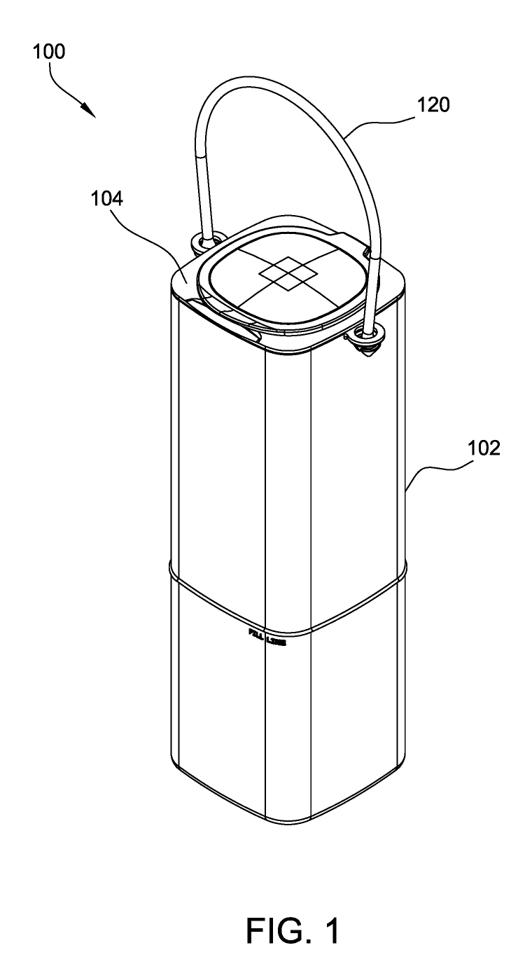

FIG. 1 is a perspective view of an exemplary trap 100 for flying insects. In the exemplary embodiment, trap 100 includes a canister 102 and a nozzle 104 coupled to canister 102. Although nozzle 104 and canister 102 are both fabricated from a rigid plastic material in the exemplary embodiment, nozzle 104 and canister 102 may be fabricated from any suitable material in other embodiments (e.g., nozzle 104 and canister 102 may be fabricated from a metal such as, for example, aluminum in some embodiment). Moreover, although nozzle 104 is coupled to canister 102 in the exemplary embodiment, nozzle 104 and canister 102 may be integrally formed together as a single-piece, unitary structure in other embodiments. Additionally, although trap 100 is illustrated as having only one canister 102 and only one nozzle 104 in the exemplary embodiment, trap 100 may have any suitable number of canisters 102 each having any suitable number of associated nozzles 104 in other embodiments (e.g., trap 100 may have one canister 102 and two nozzles 104 in some embodiments).

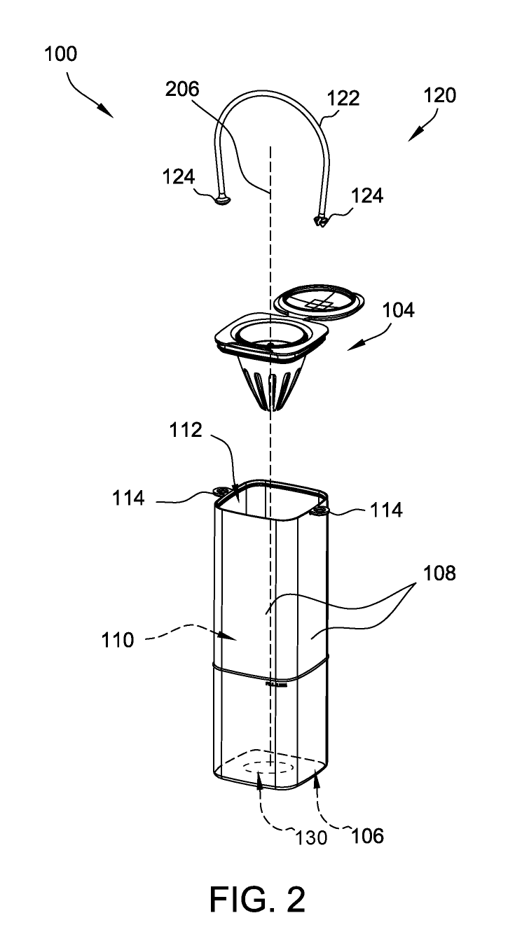

FIG. 2 is an exploded view of trap 100. In the exemplary embodiment, canister 102 has a bottom wall 106 and a plurality of side walls 108 projecting from bottom wall 106 to define an elongate interior space 110 of canister 102, such that side walls 108 collectively define a substantially square top opening 112 that provides access to interior space. An eyelet 114 is integrally formed together with at least one side wall 108 at top opening 112. Although canister 102 is substantially opaque in the exemplary embodiment (e.g., is formed from a substantially opaque plastic material, and/or has a substantially opaque wrapper around side walls 108), at least one side wall 108 of canister 102 may be substantially transparent or substantially translucent in other embodiments.

In the exemplary embodiment, trap 100 includes a handle 120 coupled to canister 102 to enable trap 100 to be hung (e.g., using a hook, a tree branch, etc.). That is, handle 120 is configured to be hung and support canister 102 and nozzle 104. Trap 100 is also configured to stand upright on bottom wall 106. Handle 120 includes a handle body 122 and a pair of end members 124. Handle body 122 is coupled to eyelets 114 as shown in FIG. 1. End members 124 secure handle 120 to eyelets 114. More specifically, end members 124 are sized to prevent end members 124 from passing through eyelet 114. In the exemplary embodiment, at least one end member 124 is deflectable to facilitate coupling handle body 122 to eyelets 114. That is, the deflectable end member 124 is engaged with eyelet 114 to deflect end member 124 and permit end member 124 to pass through eyelet 114. After passing through eyelet 114, end member 124 returns to its original size to secure handle body 122 to eyelet 114. In at least some embodiments, one or more end members are not deflectable such that the deflectable end member 124 is threaded through both eyelets 114. In other embodiments, other suitable techniques and/or handle configurations may be used to couple handle 120 to canister 102. In one example, at least one end member is selectively removable.

In the exemplary embodiment, a lure 130 is deposited within interior space 110. Lure 130 is any suitable type of lure that attracts insects and/or other animals to enter trap 100. In one example, lure 130 is a power-based lure that is dissolvable in a liquid (e.g., water). In another example, lure 130 is a liquid-based lure (e.g., sugar-based fluids or vinegar-based fluids). In a third example, lure 130 is a solid-based lure (i.e., lure 130 is not dissolved in a liquid).

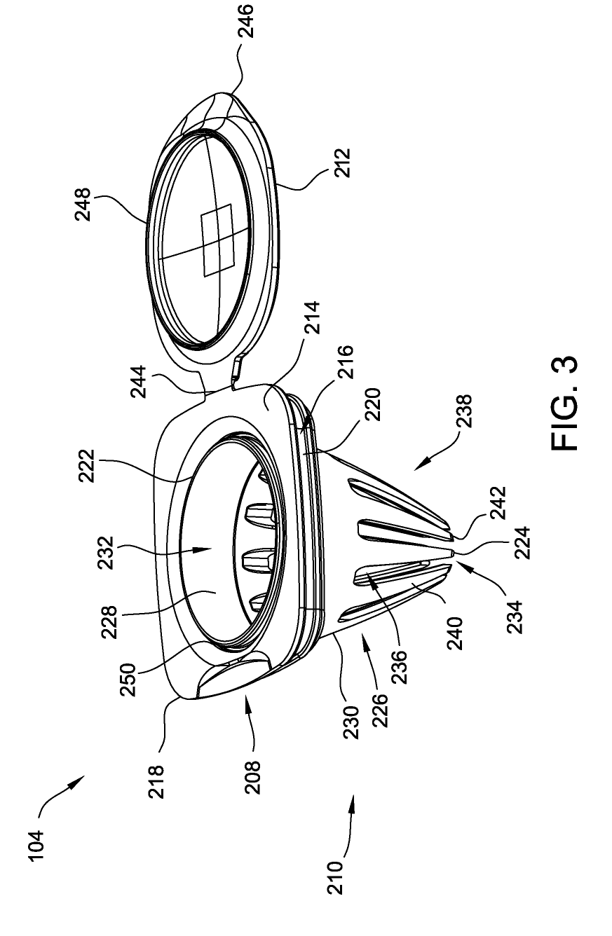

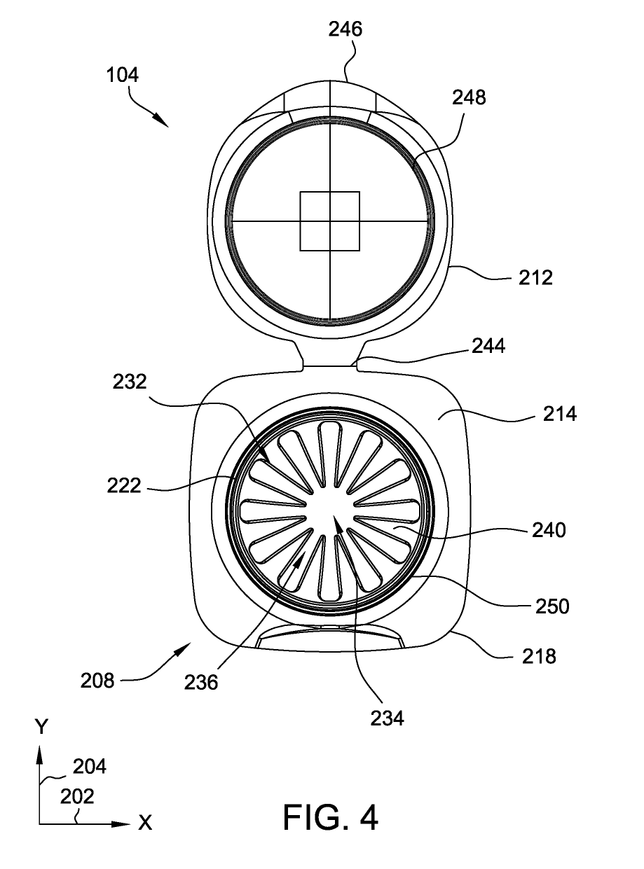

FIGS. 3 and 4 are perspective and top views, respectively, of nozzle 104. Nozzle 104 is illustrated in a three-dimensional space defined by an X-axis 202, a Y-axis 204, and a Z-axis 206 (shown in FIG. 2). In the exemplary embodiment, nozzle 104 includes a cover 208, a tube 210, and a lid 212 that are all made from a rigid plastic material and are integrally formed together as a single-piece, unitary structure. Although cover 208 has a substantially square planform shape in the exemplary embodiment (as shown in FIG. 4), cover 208 may have any suitable shape in other embodiments (e.g., cover 208 may have a substantially rectangular or substantially oval planform shape in some embodiments). Moreover, in other embodiments, nozzle 104 may be made from any suitable material (e.g., a material other than a rigid plastic), and nozzle 104 may not be a single-piece, unitary structure wherein cover 208, tube 210, and lid 212 are integrally formed together. For example, lid 212 may be formed separately from, and coupled to, cover 208 using a suitable fastener (e.g., a mechanical fastener or an adhesive fastener).

In the exemplary embodiment, cover 208 has a top wall 214 and a flexible side wall 216 extending downward from top wall 214. More specifically, top wall 214 has a peripheral edge 218, and side wall 216 includes a plurality of spaced-apart flaps 220 extending downward from top wall 214 adjacent peripheral edge 218. Although side wall 216 includes four flaps 220 in the exemplary embodiment, side wall 216 may have any suitable number of flaps 220 in other embodiments. Moreover, although top wall 214 has a substantially square peripheral edge 218 in the exemplary embodiment, peripheral edge 218 of top wall 214 may have any suitable shape in other embodiments (e.g., peripheral edge 218 may be substantially oval-shaped in some embodiments, such that each flap 220 has a substantially arcuate shape). Alternatively, cover 208 may have any suitable configuration that facilitates enabling nozzle 104 to function as described herein.

In the exemplary embodiment, tube 210 has a top end 222, a bottom end 224, and a body 226 extending from top end 222 to bottom end 224. Body 226 has an interior surface 228 and an exterior surface 230, each of which has a substantially annular top-down profile (as shown in FIG. 4). Interior surface 228 defines an inlet 232, an outlet 234, and a passageway 236 extending from inlet 232 to outlet 234. Inlet 232 has a diameter Dᵢ greater than a diameter Dₒ of outlet 234 such that interior surface 228 has a tapered shape that is substantially like an inverted frustum (i.e., interior surface 228 is substantially frustoconical). Tube 210 is oriented such that flaps 220 extends outward from exterior surface 230 of tube 210 along a plane defined by X-axis 202 and Y-axis 204. In this manner, passageway 236 extends along Z-axis 206, such that Z-axis 206 acts as a centerline axis of passageway 236. Optionally, in some embodiments, at least part of interior surface 228 and/or exterior surface 230 may not have a substantially annular top-down profile (e.g., at least part of interior surface 228 and/or exterior surface 230 may have a substantially square or rectangular top-down profile). In other embodiments, interior surface 228 may not be substantially frustoconical. For example, interior surface 228 may be shaped such that inlet 232 and outlet 234 have substantially the same size and shape (e.g., interior surface 228 may be substantially cylindrical from inlet 232 to outlet 234). Alternatively, although interior surface 228 circumscribes Z-axis 206 in the exemplary embodiment, interior surface 228 may have any suitable shape relative to Z-axis 206 in other embodiments (e.g., Z-axis 206 may not serve as a centerline axis for passageway 236 in some embodiments, but rather Z-axis 206 may be skewed relative to (i.e., may cut across) passageway 236).

Notably, a bottom part 238 of body 226 is designed to impair the vision of a flying insect (e.g. a nuisance fly such as a house fly, a blue bottle fly, a blow fly, or a canyon fly) attempting to enter passageway 236 via outlet 234. In the exemplary embodiment, bottom part 238 impairs the insect's vision by virtue of being perforated, in that bottom part 238 has a plurality of circumferentially spaced fingers 240 that converge toward outlet 234. Each finger 240 has a distal end 242, such that distal ends 242 collectively circumscribe and define outlet 234. In other embodiments, tube 210 may be perforated in any suitable manner that facilitates enabling tube 210 to perform a vision-impairing function as described herein. For example, in one embodiment, bottom part 238 may not be perforated by virtue of having fingers 240 that are spaced apart about Z-axis 206 but, rather, may instead be perforated by virtue of a mesh-like arrangement of wires (not shown) or beams (not shown). Additionally or alternatively, tube 210 may not be designed to perform its vision-impairing function by virtue of its structural configuration, but may instead have an aesthetic (or non-structural) characteristic (e.g., surface texture, color, smell, etc.) that is designed to impair the ability of a flying insect to enter passageway via outlet.

In the exemplary embodiment, lid 212 is tethered to top wall 214 via a flexible joint 244. Lid 212 is moveable between an open position (e.g., the position shown in FIGS. 2-4) and a closed position (e.g., the position shown in FIG. 1). In the exemplary embodiment, lid 212 is configured to be positioned in additional positions, such as positions between the open and closed positions. Lid 212 is rotatable around joint 244 to selectively seal passageway 236 when positioned in the closed position. As used herein, “sealing” passageway 236 prevents insects or other animals from entering or leaving through passageway 236. In at least some embodiments, lid 212 is configured to seal liquids and/or odors within canister 102 when positioned in the closed position. Conversely, when lid 212 is positioned in the open position, passageway 236 is not blocked by lid 212, thereby facilitating entry of insects within trap 100.

Lid 212 includes an upwardly-bent lip 246 and defines an annular tongue 248. Lip 246 is configured to provide a gripping point for a user to manually move lid 212 about joint 244. In that regard, top wall 214 of cover 208 defines an annular groove 250 that circumscribes inlet 232 of tube 210 and is shaped to receive tongue 248 in a sealed engagement when lid 212 is positioned in the closed position such that airflow between lid 212 and top wall 214 is at least substantially prevented when tongue 248 is seated within groove 250. That is, when tongue 248 is coupled to groove 250, passageway 236 is sealed to prevent insects from entering passageway 236 and to prevent insects and lure from exiting trap 100 through passageway 236. In one example, lid 212 is closed (i.e., moved to the closed position) to facilitate disposal of trap 100. In another example, lid 212 is closed when trap 100 is in storage or on display for purchase. To open lid 212, a user engages lip 246 and/or another portion of cover 208 or lid 212 to unseat tongue 248 from groove 250. In one embodiment, lip 246 may not be upwardly bent, or lid 212 may not have lip 246. In some embodiments, lid 212 may not be tethered to top wall 214. In other embodiments, tongue 248 and groove 250 may not be annular and/or may not completely circumscribe inlet 232 of tube 210. Alternatively, lid 212 may have any suitable configuration that facilitates enabling lid 212 to function as described herein.

Referring back to FIG. 2, when assembling trap 100, a lure 130 for a flying insect (e.g., a powder-form lure) is deposited within interior space 110 of canister 102 via top opening 112. Nozzle 104 is then coupled to canister 102 within top opening 112 by flexing side wall 216 inward until nozzle 104 snaps onto lid 212, with bottom part 238 of tube 210 disposed inside interior space of lid 212 such that top wall 214 of cover 208 is disposed on the exterior of canister 102. Additionally, lid 212 is moved in the closed position by pivoting lid 212 toward inlet of tube 210 until tongue 248 seats within groove 250 in a sealed (e.g., substantially airtight) engagement, such that lure 130 is sealed within canister 102. In other embodiments, nozzle 104 may not snap onto canister 102 in top opening 112, but rather may couple to canister 102 in any suitable manner that facilitates enabling trap 100 to function as described herein (e.g., nozzle 104 may be coupled to canister 102 via a suitable adhesive or another suitable mechanical interface).

To deploy trap 100, lid 212 is pivoted away from top wall 214 of cover 208 such that tongue 248 is removed from groove to expose inlet 232 (and, thus, interior space 110 of canister 102) to the ambient via passageway 236. That is, lid 212 is moved to the open position. A liquid (e.g., water) is then poured into canister 102 via inlet 232 such that the liquid contacts (e.g., mixes with) lure 130 inside interior space 110 of canister 102. Then, trap 100 can be stood upright on a support surface (not shown) (e.g., the ground or a table near a garbage can, a compost pile, an animal stable, or anywhere else where the trapping of insects is desired). Alternatively, trap 100 can be hung from a suitable structure (e.g., a tree branch) using handle 120.

Because air can enter and exit interior space 110 of canister 102 via nozzle 104, lure 130 attracts insects to nozzle 104, through which insects enter interior space 110 of canister 102. Due to the configuration of bottom part 238 of tube 210 (i.e., due to the visual pattern formed by fingers 240), insects that enter canister 102 through nozzle 104 have difficulty exiting canister 102 through nozzle 104. More specifically, once an insect enters interior space 110 from passageway 236 via outlet 234, the insect has difficulty visually locating outlet 234 and reentering passageway 236 from interior space 110. Thus, insects that enter interior space 110 of canister 102 tend to remain trapped inside canister 102 until they perish, at which point the insects submerge into the liquid such that the liquid mitigates the associated scent. To at least temporarily or selectively transition trap 100 into a state of being not deployed, lid 212 can be positioned in the closed position by pivoting lid 212 toward top wall 214 of cover 208 such that tongue 248 is seated within groove 250 to seal canister 102, thereby at least temporarily preventing spillage of the liquid during transport and/or at least substantially preventing a scent (e.g., the scent of the lure or the perished insects) from exiting canister 102 into the ambient. Suitably, lid 212 can be pivoted around joint 244 and away from top wall 214 of cover 208 to redeploy trap 100 as desired. Alternatively, trap 100 can be disposed of as desired, and replaced with a new trap 100 that is deployable as set forth above.

The methods and systems described herein facilitate providing a trap for flying insects. More specifically, the methods and systems facilitate providing a trap that lures flying insects into a canister via a nozzle, wherein the nozzle is constructed to inhibit the insects from exiting the canister via the nozzle. The methods and systems also facilitate providing a lid with the nozzle to enable selectively access to an interior space of the canister, and the methods and systems further facilitate providing a canister made from a rigid material to enable the canister to remain upright during deployment. Moreover, the methods and system also facilitate providing a nozzle that is shaped to facilitate improved connection (e.g., sealing connection) of the nozzle to the canister when the nozzle is snapped into place on the canister.

Exemplary embodiments of an insect trap are described above in detail. The trap described herein is not limited to the specific embodiments described herein, but rather, components of the trap may be utilized independently and separately from one another. For example, the trap described herein may have other applications not limited to practice in trapping flying insects, as described herein. Rather, the trap described herein can be implemented and utilized in connection with trapping other types of insects (or animals generally).

This written description uses example embodiments, while disclosing the best mode and enabling any person skilled in the art to practice the example embodiments, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An insect trap comprising:
a rigid canister having a bottom wall and a plurality of side walls projecting from said bottom wall, wherein said plurality of side walls define a top opening; and
a nozzle secured within said top opening, wherein said nozzle comprises a tube defining a passageway for insects to enter into said canister and a lid configured to move between an open position and a closed position, wherein said lid selectively seals said passageway when positioned in the closed position.

2. An insect trap in accordance with claim 1, wherein said nozzle further comprises a cover coupled to said tube and said lid, wherein said cover engages said plurality of side walls.

3. An insect trap in accordance with claim 2, wherein said nozzle further comprises a joint coupled between said cover and said lid, wherein said lid is rotatable around said joint.

4. An insect trap in accordance with claim 1 further comprising a handle coupled to said canister, wherein said canister is configured to hang from said handle.

5. An insect trap in accordance with claim 4, wherein said nozzle comprises a cover coupled to said tube, said cover comprising an eyelet and said handle comprising a deflectable end member and a handle body, wherein said handle body is coupled to said eyelet.

6. An insect trap in accordance with claim 1, wherein said tube defines an inlet and an outlet having a diameter less than said inlet, wherein said inlet and said outlet define said passageway therebetween.

7. An insect trap in accordance with claim 1, wherein said tube comprises a bottom part disposed within said canister, said bottom part having a plurality of fingers spaced apart from one another about said passageway.

8. A method of making an insect trap, said method comprising:
forming a lid for a nozzle that includes a tube, wherein the lid is moveable between an open position and a closed position;
positioning the nozzle between a plurality of side walls of a rigid canister, wherein the plurality of side walls define a top opening; and
coupling the nozzle to the plurality of side walls such that the tube of the nozzle defines a passageway for insects to enter into the canister, wherein the lid selectively seals the passageway when positioned in the closed position.

9. A method in accordance with claim 8 wherein coupling the nozzle to the plurality of side walls further comprises coupling a cover of the nozzle to the plurality of side walls.

10. A method in accordance with claim 9 wherein forming the lid further comprises forming a joint between the cover and the lid, wherein the lid is rotatable around the joint.

11. A method in accordance with claim 8, further comprising coupling a handle to the canister.

12. A method in accordance with claim 11, wherein coupling a handle to the canister further comprises:
engaging an eyelet of the canister with a deflectable end member of the handle, wherein the deflectable end member is configured to deflect when engaged with the eyelet to facilitate passage through the eyelet; and
coupling the eyelet to a handle body of the handle, wherein the deflectable end member secures the eyelet to the handle body.

13. A method in accordance with claim 8, further comprising depositing an insect lure within the canister to attract insects.

14. A method in accordance with claim 8, further comprising forming the tube with a bottom part having a plurality of fingers spaced apart from one another about the passageway.

15. A nozzle for an insect trap having a rigid canister including a bottom wall and a plurality of side walls projecting from the bottom wall, wherein the plurality of side walls define a top opening, said nozzle comprising:
a tube defining a passageway for insects to enter into the canister when said nozzle is coupled to the canister within the top opening; and
a lid configured to move between an open position and a closed position, wherein said lid selectively seals said passageway when positioned in the closed position.

16. A nozzle in accordance with claim 15, further comprising a cover coupled to said tube, wherein said cover is configured to be coupled to the plurality of side walls of the canister.

17. A nozzle in accordance with claim 16, further comprising a joint coupled between said cover and said lid, wherein said lid is rotatable around said joint.

18. A nozzle in accordance with claim 17, wherein said lid comprises an annular tongue and said cover comprises an annular groove, wherein said annular groove is configured to receive said annular tongue when said lid seals said passageway.

19. A nozzle in accordance with claim 15, wherein the tube comprises a bottom part for insertion within the canister, the bottom part having a plurality of fingers spaced apart from one another about the passageway.

20. A nozzle in accordance with claim 19, wherein the tube defines an inlet and an outlet that define said passageway therebetween, wherein said passageway is tapered between said inlet and said outlet.
